(19) United States
(12) Patent Application Publication
(10) Pub. No.: US 2012/0213275 A1
(43) Pub. Date: Aug. 23, 2012

(54) SCALABLE VIDEO CODING AND DEVICES PERFORMING THE SCALABLE VIDEO CODING

(76) Inventors: Nyeong-Kyu KWON, Daejeon (KR); Karimulla Shaik, Godugu palem (IN); Young-Beom Jung, Andong-si (KR); Devendran Mani, Chennai (IN); Srinivas Reddy Eregala, Nalgonda (IN); In Seo Han, Bupyeong-gu (KR)

(21) Appl. No.: 13/402,077

(22) Filed: Feb. 22, 2012

Related U.S. Application Data
(60) Provisional application No. 61/445,309, filed on Feb. 22, 2011.

(30) Foreign Application Priority Data
Jul. 11, 2011 (KR) 10-2011-0068259

(51) Int. Cl. H04N 7/12

(52) U.S. Cl. 375/240.12; 375/E07.243

(57) ABSTRACT

A data processing system includes a scalable encoder including an encoder and a control module. The encoder includes at least two layer encoders and has an encoder configuration determined during initialization. The control module is configured to generate an encoder control code in accordance with transmission conditions of a communication channel, the encoder control code controlling operation of the at least two encoding layers.

### CROSS-REFERENCE TO RELATED APPLICATION

The present application claims priority under 35 U.S.C. §119(e) to U.S. Provisional Application No. 61/445,309, filed on Feb. 22, 2011, and claims priority under 35 U.S.C. §119(a)-(d) to Korean Patent Application No. 10-2011-0068259, filed on Jul. 11, 2011, in the Korean Intellectual Property Office, and entitled: “Scalable Video Coding and Devices Performing the Scalable Video Coding.” Both applications are incorporated by reference herein in their entirety.

### BACKGROUND

1. Field

Example embodiments relate to a scalable video coding (SVC) scheme, and more particularly, to methods of performing SVC and devices capable of performing the methods.

2. Description of the Related Art

International video coding standards, such as H.261, moving picture experts group (MPEG)-1, H.262/MPEG-2 video, H.263, MPEG-4 Visual, and H.264/AVC, have played an important role in making digital video applications a success.

The H.264/AVC specification is state-of-the-art in video coding. When compared with conventional video coding standards, the H.264/AVC standard significantly decreases a bit rate necessary for representing a quality image.

### SUMMARY

Some embodiments are directed to a data processing method, including initializing an encoder configuration for an encoder having at least a first layer encoder and a second layer encoder, determining transmission conditions of a communication channel, generating an encoder control signal in accordance with the transmission conditions, and controlling at least one of the first and second layer encoders to encode at least a coding layer in accordance with the encoder control signal.

Controlling the first and second layer encoders may include controlling each of the first and second layer encoders enabled in accordance with the encoder control signal to perform one of an intra-encoding operation, an inter-encoding operation, a slice-skip encoding operation, and a no-encoding operation based on the encoder control signal.

As the transmission conditions improve, the method may increase a number of layer encoders enabled by the encoder control signal,

The method may include determining the coding layer from among at least two layers in accordance with the transmission conditions of the channel.

When the coding layer is an uppermost layer, the method may include transmitting the encoded coding layer and, when the coding layer is not the uppermost layer, the method may include transmitting the encoded coding layer and at least one scaling factor.

The at least one scaling factor may be from a layer other than the coding layer.

The controlling may include controlling the first and second layer encoders to encode the coding layer and all layers above the coding layer.

The controlling may include controlling the first and second layer encoders to encode the coding layer and all layers below the coding layer.

The controlling may include controlling the first and second layer encoders to encode only the coding layer.

When more than one layer encoder is enabled, a lower layer encoder may encode an input bit stream and output inter-layer prediction information to an upper layer encoder.

The upper layer encoder may output a scaling factor.

The lower encoding layer may output an encoded bit stream.

The method may include receiving an encoded coding layer over the communication channel, decoding the encoded coding layer, and adjusting a resolution of a decoded coding layer.

Adjusting the resolution may include using a scaling factor from a layer other than the coding layer.

Adjusting the resolution may include using a predetermined scaling factor.

Decoding may include generating a decoding control signal for controlling at least two layer decoders, corresponding to the at least two layer encoders.

When more than one layer decoders is enabled, a lower layer decoder may decode the encoded coding layer and output inter-layer prediction information to an upper layer decoder.

The method may include supplying only an output of the upper layer decoder to a decoded buffer.

When the upper layer decoder receives only a header from a coded buffer, adjusting the resolution of the decoded coding layer may include using a scaling factor from the header to adjust the resolution of the decoded coding target layer output by the lower layer decoder.

Controlling the first and second layer encoders may include simultaneously enabling the first and second layer encoders, multiplexing outputs from the first and second layer encoders, and outputting outputs from the first and second layer encoders in accordance with the encoder control signal.

The method may include repeating determining, generating, and controlling for all access units.

When no coding layer is found for a current access unit based on current transmission conditions, the method may skip the current access unit.

Some embodiments are directed to a scalable encoder, including an encoder including at least two layer encoders, and a control module configured to generate a encoder control code in accordance with transmission conditions of a communication channel, the encoder control code controlling operation of the at least two layer encoders.

The encoder and the control module may be incorporated in a single chip.

The control module may include a transmission condition estimator configured to estimate current transmission conditions of the communication channel.

The control module may include an encoding type decision block configured to determine a coding layer based on the current transmission conditions.

The scalable encoder may include a transmission buffer, wherein the transmission condition estimator estimates current transmission conditions based on a bit level of the transmission buffer.

The transmission buffer may be on the single chip.

The encoder may include a multiplexer configured to receive encoded coding layers encoded by the at least two layer encoders and to selectively output encoded coding layers in accordance with the encoder control code.

The encoder control code simultaneously enables all of the at least two layer encoders.

The control module may be configured to control each layer encoder to perform one of an intra-encoding operation, an inter-encoding operation, a slice-skip encoding operation, and a no-encoding operation based on the encoder control signal.

As transmission conditions of the communication channel improve, the encoder control code may enable more layer encoders or fewer layer encoders.

The encoder control code may enable only one layer encoder.

Some embodiments are directed to a data processing system, including a scalable encoder including an encoder and a control module, wherein the encoder includes at least two layer encoders and has an encoder configuration determined during initialization, the control module is configured to generate a encoder control code in accordance with transmission conditions of a communication channel, the encoder control code controlling operation of the at least two encoding layers.

The encoder and the control module may be incorporated in a single chip.

The data processing system may include a monitor in the scalable encoder, the monitor configured to perform a handshake operation over the communication channel and supplying transmission conditions of the communication channel to the control module.

The control module may be configured to control each layer encoder to perform one of an intra-encoding operation, an inter-encoding operation, a slice-skip encoding operation, and a no-encoding operation based on the encoder control signal.

As transmission conditions of the communication channel improve, the encoder control code may enable more layer encoders or fewer layer encoders.

The encoder control code may enable only one layer encoder.

The data processing system may include a scalable decoding device including a scalable decoder having at least two layer decoders, corresponding to the at least two layer encoders of the scalable encoder, the scalable decoder configured to decode an encoded coding layer and the scalable decoding device configured to adjust a resolution of the decoded coding layer.

The data processing system may include a decoded picture buffer, the decoded picture buffer receiving a single output from the scalable decoder.

The scalable decoder may include a control block configured to supply encoded information to respective layer decoders.

When the control block enables more than one layer decoder, a lower decoding layer may decode an encoded coding layer and output inter-layer prediction information to an upper layer decoder.

When the upper layer decoder receives only a header from the control block, the scalable decoding device may adjust the resolution of the decoded coding layer using a scaling factor from the header to adjust the resolution of the decoded coding layer output by the lower decoding layer.

The data processing system may include a scaler external to the scalable decoder, the scaler configured to scale an output from the scalable decoder, the control block being configured to control operation of the scaler.

When the control block enables the scaler, the control block may generate a scaling factor to be used by the scaler.

When the control block enables more than one layer decoder, a lower layer decoder may decode the encoded coding layer and output inter-layer prediction information to an upper layer decoder.

When the control block only enables a single layer decoder, the control block may enable the scaler to adjust the resolution of an output from the single layer decoder using a predetermined scaling factor.

The scalable encoder may be implemented as a first system on chip and the scalable decoding device is implemented as a second system on chip.

The scalable encoder and the scalable decoding device may be on a single system on chip.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1A illustrates a block diagram of a data processing system according to an embodiment that includes a scalable encoder and a scalable decoder;

FIG. 1B illustrates a block diagram of a data processing system according to another embodiment that includes a scalable encoder and a scalable decoder;

FIG. 2A illustrates a block diagram of an embodiment of the encoder included in the data processing system of FIG. 1A or 1B;

FIG. 2B illustrates a block diagram of another embodiment of the encoder included in the data processing system of FIG. 1A or 1B;

FIG. 3 is a block diagram of an embodiment of the decoder included in the data processing system of FIG. 1A or 1B;

FIG. 4 illustrates a flowchart of a method of operating the scalable encoder of FIG. 1A or 1B, according to an embodiment;

FIG. 5 illustrates a flowchart of a method of operating the scalable encoder of FIG. 1A or 1B, according to another embodiment;

FIG. 6 illustrates a timing diagram for explaining an operation of the scalable encoder included in the data processing system of FIG. 1A or 1B based on variation of a bandwidth of a communication channel, according to an embodiment;

FIG. 7 illustrates a flowchart of a method of operating the scalable decoder of FIG. 1A or 1B, according to an embodiment;

FIG. 8 illustrates a timing diagram for explaining an operation of the scalable encoder included in the data processing system of FIG. 1A or 1B based on variation of a bandwidth of a communication channel, according to another embodiment;

FIG. 9 illustrates a timing diagram for explaining an operation of the scalable encoder included in the data processing system of FIG. 1A or 1B based on variation of a bandwidth of a communication channel, according to still another embodiment;

FIG. 10 illustrates a flowchart of a method of operating the scalable decoder of FIG. 1A or 1B, according to another embodiment;

FIG. 11 illustrates a block diagram of a data processing system according to another embodiment that includes a scalable encoder and a scalable decoder; and

FIG. 12 illustrates a block diagram of a data processing system according to still another embodiment that includes a scalable encoder and a scalable decoder.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The scalable encoder according to an embodiment denotes an encoder capable of performing scalable video coding (SVC) or multi-resolution video coding, and the scalable decoder according to an embodiment of denotes a decoder capable of performing SVC or multi-resolution video coding. Annex G extension of the H.264/MPEG-4 Advanced Video Coding (AVC) video compression standard is incorporated herein as a reference in a scalable encoder and/or a scalable decoder according to embodiments. Scalability may include temporal, spatial, and/or quality scalability.

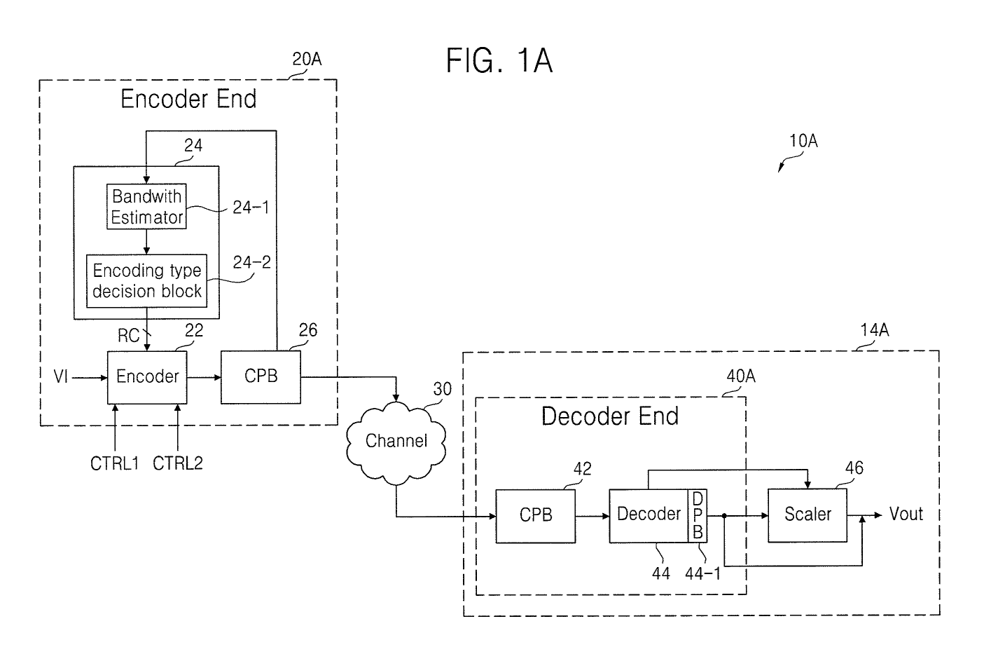

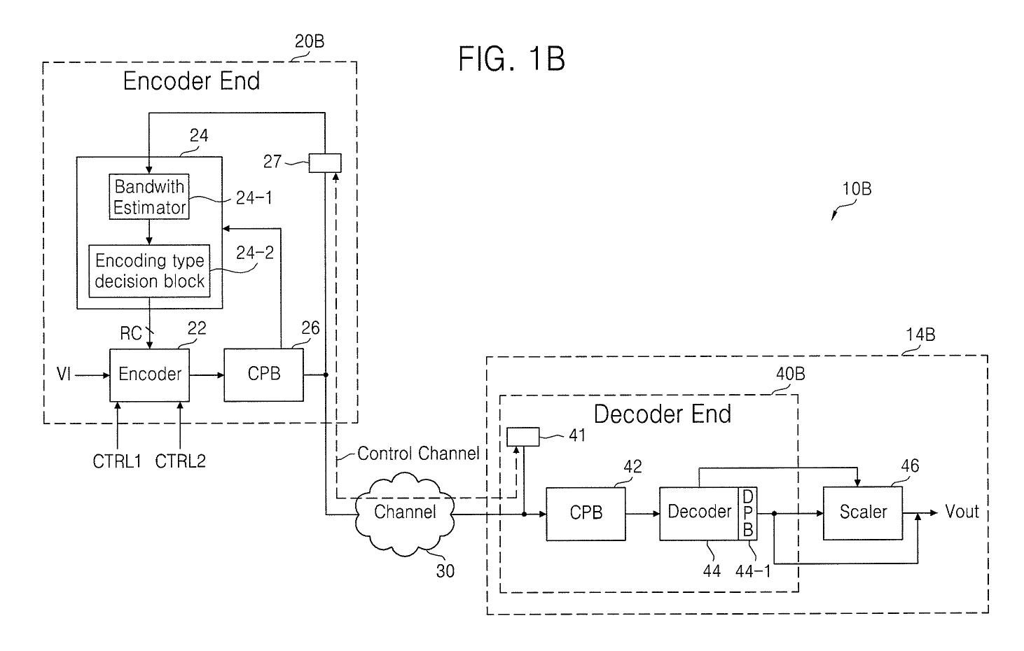

FIG. 1A illustrates a block diagram of a data processing system 10A according to an embodiment. As shown in therein, the data processing system 10A includes a scalable encoder 20A and a scalable decoder 40A.

In detail, referring to FIG. 1A, the data processing system 10A includes the scalable encoder 20, a communication channel 30, and the scalable decoder 40. A scalable decoding device 14A includes the scalable decoder 40A and a scaler 46. The scalable encoder 20A may be referred to as an encoder end, and the scalable decoder 40A may be referred to as a decoder end.

The scalable encoder 20A and/or the scalable decoder 40A may be implemented in a mobile TV, a digital TV (DTV), a high definition TV (HDTV), an Internet protocol TV (IPTV), a wireless and Internet video streaming system, a multimedia messaging system, a video telephony system, a video conferencing system, a cable TV, direct broadcast satellite (DBS) video services, digital subscriber line (DSL) video services, digital terrestrial television broadcasting (DTTB), interactive storage media (ISM), multimedia mailing (MMM), multimedia services over packet networks (MSPN), real-time conversional (RTC) services, remote video surveillance (RVC), serial storage media (SSM), and so forth. Also, the scalable decoding device 14A may be implemented in any one of the described devices or applications.

According to an embodiment, the scalable encoder 20A and the scalable decoder 40A may be implemented in an identical video signal processing device (or system) or different video signal processing devices (or systems). According to another embodiment, the scalable encoder 20A and the scalable decoder 40A may be implemented into a System on Chip (SoC). According to still another embodiment, each of the scalable encoder 20A and the scalable decoder 40A may be implemented into a different SoC.

The scalable encoder 20A encodes, as a coding layer or a virtual target layer, a layer selected from a plurality of dependency layers or a plurality of spatial-layers according to a result of monitoring or analysis of time varying transmission conditions, for example, the bandwidth of a time varying communication channel 30, and transmits an encoded coding layer corresponding to a result of the encoding to the communication channel 30. For example, each of the dependency layers may be generated from a single raw video signal VI.

As used herein, a layer denotes a sequence of video frames or bit streams, and an encoded coding layer denotes scaled bit streams.

The scalable encoder 20A includes an encoder 22, a control module 24, and a transmission buffer 26. According to another embodiment illustrated in FIG. 1B, a scalable encoder 20B may include the encoder 22, the control module 24, the transmission buffer 26, and may further include a first monitor 27.

According to an encoder control code RC output from the control module 24, the encoder 22 encodes the raw video signal VI output from a video source, generates an encoded coding layer according to an SVC scheme or a multi-resolution coding scheme, and transmits the encoded coding layer to the transmission buffer 26.

The control module 24 is capable of being implemented into a circuit, a logic, a code, or a combination thereof. The control module 24 may analyze the bandwidth of the communication channel 30 and output the encoder control code RC capable of controlling an encoding operation of the encoder 22 according to a result of the analysis. The encoder control code RC may include a plurality of bits.

The control module 24 includes a bandwidth estimator 24-1 and an encoding type decision block 24-2.

According to an embodiment, the bandwidth estimator 24-1 of the control module 24 may estimate transmission conditions, for example, a bandwidth, of the communication channel 30 according to the bit level of the transmission buffer 26, for example, a coded picture buffer (CPB), which transmits the encoded coding layer to the communication channel 30 and may output estimation information according to a result of the estimation. The encoding type decision block 24-2 of the control module 24 may generate the encoder control code RC capable of controlling each of a plurality of layer encoders according to the estimation information.

For example, when the CPB 26 is implemented as an a first-in-first-out (FIFO) buffer, the bit level of the CPB 26 is an index that represents the number of bit streams accumulated in the CPB 26. Accordingly, as the bandwidth of the communication channel 30 that uses a bit per second (bps) as a basic unit increases, the level of the CPB 26 decreases. As the bandwidth of the communication channel 30 decreases, the level of the CPB 26 increases. In other words, the bandwidth of the communication channel 30 is inversely proportional to the level of the CPB 26.

As described in FIG. 1B, to determine a bit rate of an encoded coding layer transmitted from the CPB 26 of the scalable encoder 20B to the CPB 42 of a scalable decoder 40B via the communication channel 30, the first monitor 27 of the scalable encoder 20B performs handshaking with a second monitor 41 of the scalable decoder 40B via a control channel.

For example, when the first monitor 27 transmits a request signal to the second monitor via the control channel included in the communication channel 30, the second monitor 41 monitors a bit rate of the encoded coding layer and transmits a response signal, i.e., bit rate information according to a result of the monitoring to the first monitor 27 through the control channel in response to the request signal.

Using the handshaking, the first monitor 27 of the scalable encoder 20B may determine a bit rate of the encoded coding layer transmitted through the communication channel 30 and transmit transmission condition information indicating transmission conditions, for example, the bandwidth, of the communication channel 30 to the first monitor 27 of the control module 24 according to a result of the determination.

At this time, the bandwidth estimator 24-1 may analyze the transmission condition information output from the first monitor 27 and output estimation information according to a result of the analysis. The encoding type decision block 24-2 of the control module 24 may generate an encoder control code RC capable of controlling each of the plurality of layer encoder according to the estimation information.

According to some embodiments, the second monitor 41 may periodically determine a bit rate of the encoded coding layer and transmit bit rate information to the first monitor 27.

The bandwidth estimator 24-1 of the control module 24 may estimate proper bit-budgets of each access unit (AU) by using transmission conditions, for example, the bit level of the transmission buffer 26, or the transmission condition information output from the first monitor 27, i.e., the bit rate of the encoded coding layer fed back from the scalable decoder 40, and may output estimation information to the encoding type decision block 24-2.

As shown in FIG. 1A or FIG. 1B, the bandwidth estimator 24-1 of the control module 24 may monitor a bit level of the CPB 26 in order to determine whether the operation of the encoder 22 is properly controlled by the control module 24 and may generate the estimation information according to a monitoring result.

An encoded coding layer, i.e., scaled bit streams, stored in the CPB 26 may be transmitted to the scalable decoder 40A, 40B or decoding block 14A, 14B via the communication channel 30.

The scalable decoder 40A receives the encoded coding layer via the communication channel 30, decodes the encoded coding layer, and adjusts the resolution of a decoded coding layer corresponding to a result of the decoding using a scaling factor so that the resolution is suitable for a display (not shown).

The scalable decoding device 14A includes the scalable decoder 40A including a receiving buffer 42, a decoder 44, and a decoder buffer 44-1, and a scaler 46. According to some embodiments, the scalable decoding device 14B further includes the second monitor 41.

The receiving buffer 42, for example, the CPB 42, receives at least one encoded coding layer and/or at least one scaling factor via the communication channel 30 and stores the encoded coding layer.

The decoder 44 receives the encoded coding layer from the receiving buffer 42, decodes the encoded coding layer, and transmits the decoded coding layer to the decoder buffer 44-1, for example, a decoded picture buffer (DPB).

When the scaler 46 is implemented outside of the scalable decoder 40A, 40B, the scaler 46 is enabled or disabled in response to a first control code output from the decoder 44. In addition, the scaler 46 scales up or scales down the decoded coding layer received from the decoder buffer 44-1, e.g., a decoded video, using a second control code including the scaling factor, and outputs a scale adjusted decoded coding layer Vout to the display.

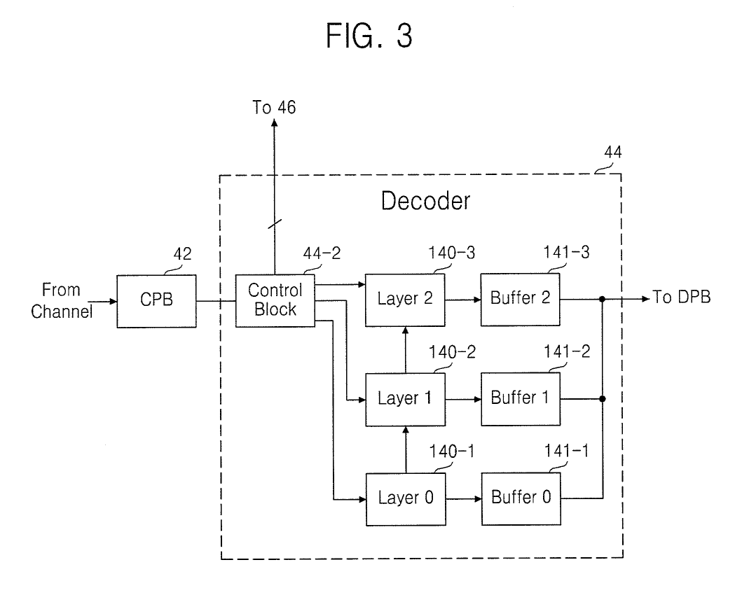

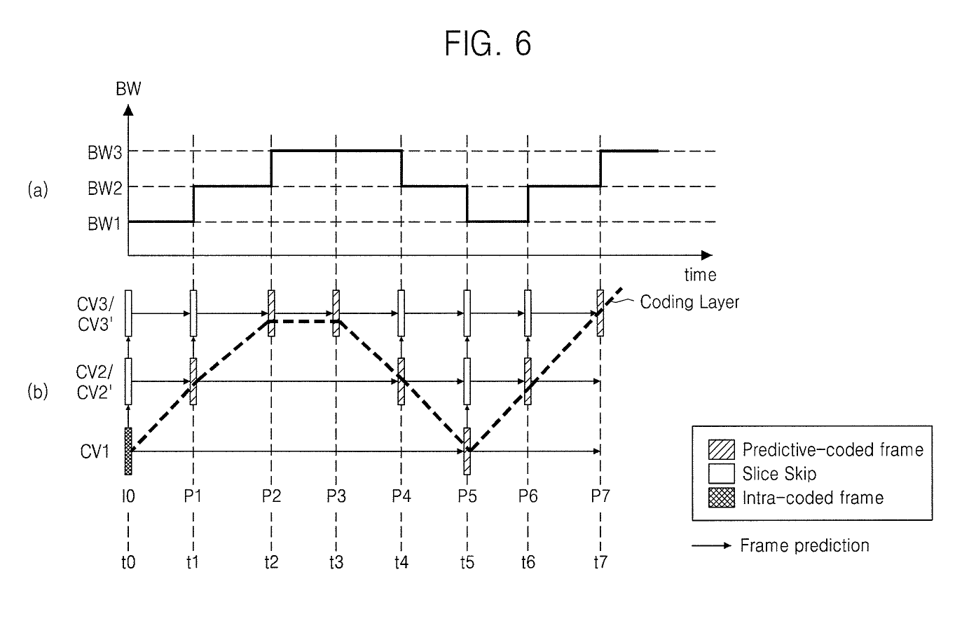

In some embodiments, as shown in FIGS. 3, 8, and 9, the scaler 46 may adjust the resolution of the decoded coding layer using the second control code so that the resolution is suitable for the display. In some embodiments, as shown in FIGS. 3 and 6, the scaler 46 is disabled in response to the first control code. Thus, the decoding layer output from the decoder buffer 44-1 bypasses the scaler 46.

The scaling factor output from the scalable encoder 20 may be one of the following factors.

1. a spatial scalability factor, for example, a spatial resolution scaling factor,

2. a combined factor of spatial scalability factor and temporal scalability factor, for example, a combined factor of spatial resolution scaling factor and temporal resolution scaling factor,

3. a combined factor of spatial scalability factor and quality scalability factor, for example, a combined factor of spatial resolution scaling factor and signal-to-noise ratio (SNR), and

4. a combined factor of spatial scalability factor, temporal scalability factor, and quality scalability factor.

Accordingly, the scaling factor output from the scalable encoder 20 may include at least the spatial scalability factor, e.g., a spatial resolution scaling factor.

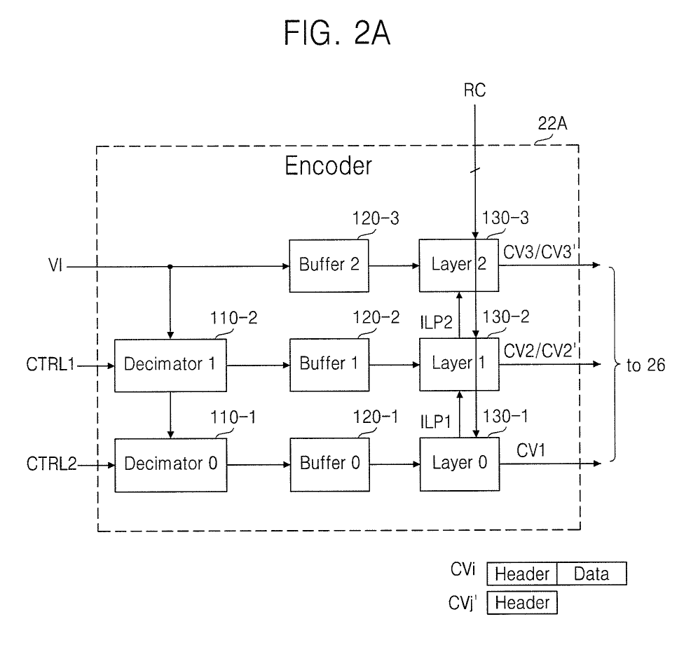

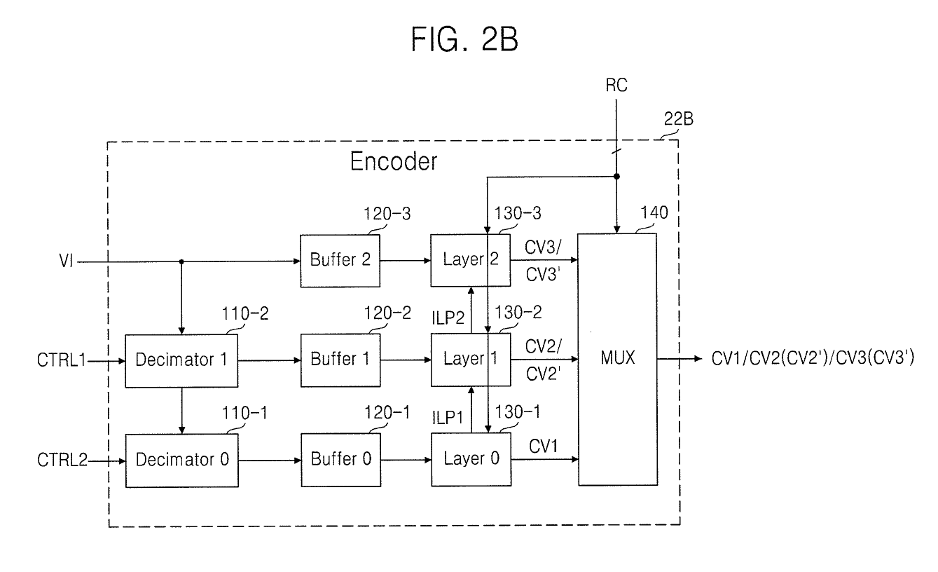

FIG. 2A illustrates a block diagram of an embodiment of the encoder 22 illustrated in FIG. 1A or 1B. Referring to FIG. 2A, an encoder 22A, which is an embodiment of the encoder 22 of FIG. 1A or 1B, includes a plurality of decimators, e.g., first and second decimators 110-1 and 110-2, a plurality of buffers, e.g., first, second, and third buffers 120-1, 120-2, and 120-3, and a plurality of layer encoders, e.g., first, second, and third layer encoders 130-1, 130-2, and 130-3. For example, each of the first and second decimators 110-1 and 110-2 may be implemented into a spatial decimator.

Although the three layer encoders 130-1, 130-2, and 130-3 are illustrated in FIG. 2A for convenience of explanation, two or more layer encoders may be used. Further, the encoder 22 may scalable-encode three dependency layers or three spatial layers.

It is assumed that the raw video signal VI is a 4 common intermediate format (4CIF), the second decimator 110-2 outputs a video signal with a CIF by decimating the raw video signal VI with the 4CIF, and the first decimator 110-1 outputs a video signal with a Quarter CIF (QCIF) by decimating the video signal with the CIF. Here, a plurality of dependency layers includes the 4CIF, CIF, and QCIF.

The raw video signal VI is scaled down or decimated to a lower resolution by each of the first and second spatial decimators 110-1 and 110-2, and scaled down video signals by the first and second spatial decimators 110-1 and 110-2 are output to the first and second buffers 120-1 and 120-2, respectively. For example, each of the first and second spatial decimators 110-1 and 110-2 may scale down the raw video signal VI according to a scale ratio set by each of control parameters CTRL1 and CTRL2.

Enabling and disabling of the first, second, and third layer encoders 130-1, 130-2, and 130-3 may be independently determined according to the encoder control code RC. According to an embodiment, an order in which the first, second, and third layer encoders 130-1, 130-2, and 130-3 are enabled and/or an order in which the first, second, and third layer encoders 130-1, 130-2, and 130-3 are disabled may be determined according to the encoder control code RC. For example, as the bandwidth of the communication channel 30 increases, the number of encoders enabled may increase.

An encoding operation proceeds from the first layer encoder 130-1, which is a lower layer encoder, to the third layer encoder 130-3, which is an upper layer encoder.

The encoding operation set by the encoder control code RC includes an intra-encoding operation, an inter-encoding operation, a slice-skip operation, and no-encoding operation. The intra-encoding operation, the inter-encoding operation, the slice-skip operation, or the no-encoding operation of each of layer encoders 130-1, 130-2, and 130-3 may be independently determined according to the control code RC.

In the intra-encoding operation, a layer encoder encodes a current frame to generate I-frame, i.e., intra-coded frame. In the inter-encoding operation, a layer encoder encodes differences between a current frame and a previous frame to generate P-frame or B-frame, i.e., predictive-coded frame. In the slice-skip operation, a layer encoder encodes input frame by using only inter-layer prediction information and outputs a header including scaling information. In the no-encoding operation, a layer encoder is disabled. Thus, the layer encoder does not encode an input frame.

Each frame includes a plurality of macroblocks, and the encoding is performed in units of frames.

When a base layer encoder or a first layer encoder 130-1 performs an intra-encoding operation according to the encoder control code RC, the first layer encoder 130-1 receives and encodes a current frame with the QCIF from the first buffer 120-1, and generates an encoded first coding layer CV1 (hereinafter, referred to as a first coding layer) and a first inter-layer prediction information ILP1.

The first inter-layer prediction information ILP1 is used during an encoding operation of the second layer encoder 130-2 in order to increase coding efficiency of the second layer encoder 130-2.

When an enhancement layer encoder or the second layer encoder 130-2 performs an intra-encoding operation according to the encoder control code RC, the second layer encoder 130-2 encodes a current frame with the CIF output from the second buffer 120-2 into an encoded second coding layer CV2 (hereinafter, referred to as a second coding layer) using the first inter-layer prediction information ILP1 and outputs the second coding layer CV2 and a second inter-layer prediction information ILP2.

The second inter-layer prediction information ILP2 is used during an encoding operation of the third layer encoder 130-3 in order to increase coding efficiency of the third layer encoder 130-3.

When an enhancement layer encoder or the third layer encoder 130-3 performs an intra-encoding operation according to the encoder control code RC, the third layer encoder 130-3 encodes a current frame with the 4CIF output from the third buffer 120-3 into an encoded third coding layer CV3 (hereinafter, referred to as a third coding layer) using the second inter-layer prediction information ILP2 and outputs the third coding layer.

When each layer encoder 130-1, 130-2, and 130-3 performs an inter-encoding operation according to the encoder control code RC, each layer encoder 130-1, 130-2, and 130-3 encodes differences between a previous frame and a current frame output from each buffer 120-1, 120-2, and 120-3, and outputs each coding layer CV1, CV2, and CV3.

However, during a slice-skip operation, each of the second and third layer encoders 130-2 and 130-3 outputs minimum bits, e.g., a scaling factor, i.e., a scale ratio, set by SVC syntax elements according to the encoder control code RC.

During no-encoding operation, each layer encoder 130-1, 130-2, and 130-3 is disabled according to the encoder control code RC. Thus, an encoding operation is not performed.

As shown in FIG. 2A, each coding layer CVi (where, i=1, 2, and 3) includes a header and data, the header includes a scaling factor and control information. However, each slice-skip layer CVj′ (where, j=2 and 3) includes a slice-unit header including a scaling factor.

FIG. 2B illustrates a block diagram of another embodiment of the encoder included in the data processing system illustrated in FIG. 1A or 1B. Referring to FIG. 2B, an encoder 22B, which is another embodiment of the encoder 22 of FIG. 1A or 1B, includes the plurality of decimators, i.e., the first and second decimators 110-1 and 110-2, the plurality of buffers, i.e., the first, second, and third buffers 120-1, 120-2, and 120-3, the plurality of layer encoders, i.e., the first, second, and third layer encoders 130-1, 130-2, and 130-3, and a multiplexer (MUX) 140.

The first, second, and third layer encoders 130-1, 130-2, and 130-3 are simultaneously enabled and disabled according to the encoder control code RC. Accordingly, the first, second, and third layer encoders 130-1, 130-2, and 130-3 output first, second, and third coding layers CV1, CV2, and CV3, respectively, to the MUX 140.

The MUX 140 selectively outputs the first, second, and third coding layers CV1, CV2, and CV3 according to the encoder control code RC. The encoder control code RC may include bits capable of controlling of operations of the respective first, second, and layer encoders 130-1, 130-2, and 130-3, and bits capable of controlling of an operation of the MUX 140.

During an intra-coding operation or an inter-coding operation, the MUX 140 selectively outputs the first, second, and third coding layers CV1, CV2, and CV3 according to the encoder control code RC. During a slice-skip operation, the MUX 140 selectively outputs respective slice-skip layer CV2′ and CV3′ including respective scaling factor according to the encoder control code RC. During no-encoding operation, the MUX 140 does not output any layer CV1, CV2, CV3, CV2′, and CV3′ according to the encoder control code RC.

FIG. 3 illustrates a block diagram of an embodiment of the decoder 44 included in the data processing system 10A, 10B of FIG. 1A or 1B.

Referring to FIG. 3, the decoder 44 includes a control block 44-2, a plurality of layer decoders 140-1, 140-2, and 140-3, and a plurality of output buffers 141-1, 141-2, and 141-3. The control block 44-2 controls each operation of the plurality of layer decoders 140-1, 140-2, and 140-3, and each operation of the plurality of output buffers 141-1, 141-2 and 141-3.

The control block 44-2 may output the first control code and/or the second control code according to the encoded coding layer or slice-skip layer output from the CPB 42.

The scaler 46 is enabled or disabled based on the first control code. The scaling factor of the scaler 46 is determined by the second control code.

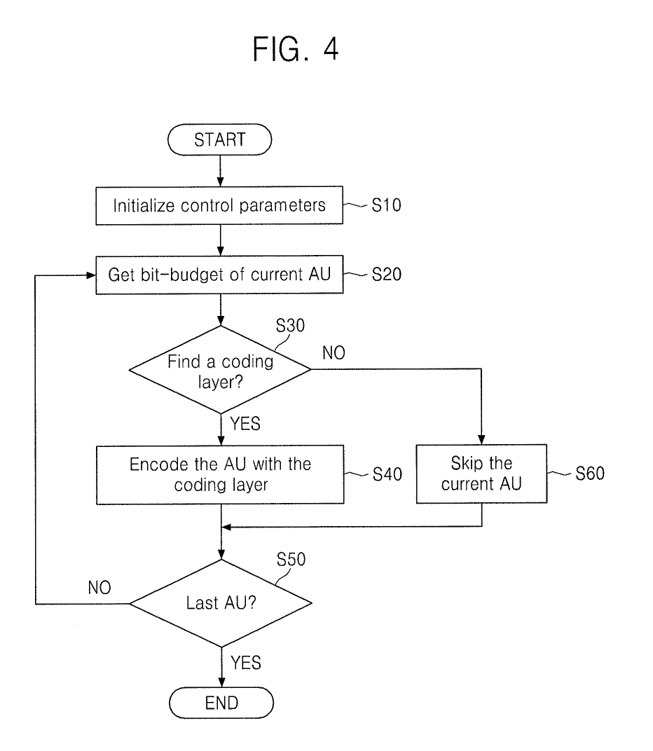

FIG. 4 illustrates a flowchart of a method of operating the scalable encoder 20A, 20B of FIG. 1A or 1B, according to an embodiment. Referring to FIGS. 1A, 1B, 2A, 2B, and 4, when encoding starts, all control parameters, for example a type of group of picture (GOP) or scaling factor are calculated and initialized, in operation S10. The parameters can have different values according to multi resolution coding scheme. For example, a total sum of bit rates Rₜ(i) accumulated up to a layer i from a lowest layer 0, may be calculated by Equation 1:

$${R}_{t} ( i ) = {\sum }_{i} R ( i ) , i ∈ \{ 0 … n \} \qquad ( 1 )$$

where B(0) is the network bandwidth at the start of encoding, R(i) is the bit rate at layer i, which is set according to the encoding mode, and n is the maximum number of layers.

A bit-budget is allocated to each of a plurality of dependency layers according to a pre-defined bits-size for each dependency layer required to satisfy a target resolution. During the encoding, an available bit-budget of the communication channel 30 with respect to a current AU, for example, the bandwidth of the communication channel 30, is analyzed, in operation S20. The current AU refers to a set of frames at each time point.

When the bandwidth of the communication channel 30 is analyzed, one layer of the plurality of dependency layers is selected as a coding layer or target layer according to a result of the analysis, in operation S30. For example, layers may be iteratively searched to determine a coding layer for which the accumulated bit rate from the lowest layer best matches the available network bandwidth. Assume that the network bandwidth at an instant time and sum of bit rates at a layer are denoted by B(t) and Rₜ(i). A best matching layer can be searched by the following Equation 2.

$$Arg {min}_{i ∈ \{ 0 … n \}} \{ B ( t ) - {R}_{t} ( i ) \} , where {R}_{t} ( i ) \leq {B}_{t} ( i ) \qquad ( 2 )$$

When no layer is selected as a coding layer, the current AU is skipped, in operation S60.

When a layer is selected as the coding layer, the current AU is encoded with the coding layer, in operation S40. Examples of the encoding will be described in detail below with reference to FIGS. 6 and 8 to 9.

In operation S50, it is determined whether the current AU is the last AU. When the current AU is the last AU, the encoding operation is concluded. On the other hand, when the current AU is not the last AU, operations S20, S30, S40, and S50 are repeated until the current AU is the last AU.

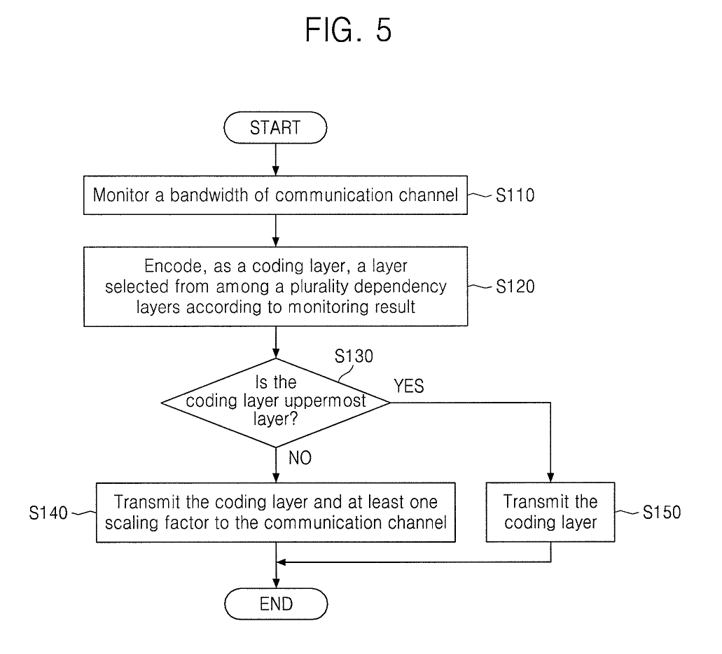

FIG. 5 illustrates a flowchart of a method of operating the scalable encoder 20A, 20B of FIG. 1A or 1B, according to another embodiment. Referring to FIGS. 1A, 1B, 2A, 2B, and 5, the scalable encoder 20A, 20B monitors or analyzes the bandwidth of the time varying communication channel 30, in operation S110.

In operation S120, the scalable encoder encodes, as a coding layer, a layer selected from among a plurality of dependency layers according to a result of the monitoring or analysis. Examples of the encoding will be described in detail below with reference to FIGS. 6 and 8 to 9.

When the encoded coding layer is determined to be an uppermost layer in operation 5130, the scalable encoder transmits the encoded coding layer corresponding to a result of the encoding to the communication channel 30 in operation S150. When the encoded coding layer is determined not to be an uppermost layer in operation S130, the scalable encoder transmits the encoded coding layer and at least one scaling factor to the communication channel 30 in operation S140.

FIG. 6 illustrates a timing diagram for explaining an operation of the scalable encoder included in the data processing system of FIG. 1A or 1B based on variation of a bandwidth of a communication channel, according to an embodiment.

Referring to FIGS. 1A, 2A, and 3, it is assumed that a display on which a decoded coding layer obtained by the scalable decoder 40A, 40B or the scalable decoding device 14A, 14B is displayed always displays an uppermost layer, i.e., a target resolution is fixed, and the scaler 46 is disabled based on the first control code. In other words, according to the present embodiment, coding efficiency may be maximized by allocating most bit-budget to a certain spatial scalable layer, i.e. the coding layer selected in operation S30 or operation S120, and allocating minimal bits to other remaining coding layers above the target layer, if any. For example, all layers above the coding layer may be coded in a slice_skip mode. All layers lower than the coding layer may not be coded. Thus, the present embodiment provides implicit switching in which the resolution is effectively changed by minimizing the coded bits in layers other than the coding layer.

Referring to FIGS. 1A, 2A, 3, and 6, when the bandwidth BW of the time varying communication channel 30 has a first value BW1, at time point t0, the first layer encoder 130-1 performs an intra-encoding on the current frame, i.e., QCIF output from the first buffer 120-1, based on the encoder control code RC, and generates the first coding layer CV1, i.e., the intra-coded frame I0 and the first inter-layer prediction information ILP1.

At time point t0, the second layer encoder 130-2 generates the first slice-skip layer CV2′ and the second inter-layer prediction information ILP2 by using the first inter-layer prediction information ILP1. The first slice-skip layer CV2′ includes slice-unit header including a scaling factor.

At time point t0, the third layer encoder 130-3 generates the second slice-skip layer CV3′ using the second inter-layer prediction information ILP2. The second slice-skip layer CV3′ includes a slice-unit header including a scaling factor.

Referring to FIGS. 1A, 2B, 3, and 6, when the bandwidth BW of the time varying communication channel 30 has a first value BW1, at time point t0, each layer encoder 130-1, 130-2, and 130-3, which is enabled according to the encoder control code RC, outputs each coding layer CV1, CV2, and CV3.

According to the encoder control code RC, the MUX 140 sequentially output the first coding layer CV1, the first slice-skip layer CV2′, and the second slice-skip layer CV3′. Accordingly, when the bandwidth BW of the time varying communication channel 30 has a first value BW1, at time point t0, the first coding layer CV1, the first slice-skip layer CV2′ and the second slice-skip layer CV3′ are transmitted to the CPB 42 through the CPB 26 and the communication channel 30.

When the first coding layer CV1, the first slice-skip layer CV2′, and the second slice-skip layer CV3′ are transmitted to the CPB 42, the control block 44-2 outputs the first coding layer CV1 to the first layer decoder 140-1, outputs the first slice-skip layer CV2′ to the second decoder 141-2, and outputs the second slice-skip layer CV3′ to the third decoder 141-3. At this time, the control block 44-2 outputs the first control code to the scaler 46. Accordingly, the scaler 46 is disabled.

The first layer decoder 140-1 decodes the first coding layer CV1 and outputs the decoding layer to the first output buffer 141-1. The first layer decoder 140-1 generates inter-layer prediction information and outputs the inter-layer prediction information to the second layer decoder 140-2.

The second layer decoder 140-2 decodes the first slice-skip layer CV2′ using the inter-layer prediction information output from the first layer decoder 140-1 and transmits the decoding layer to the second output buffer 141-2. The second layer decoder 140-2 generates inter-layer prediction information and outputs the inter-layer prediction information to the third layer decoder 140-3.

The third layer decoder 140-3 decodes the second slice-skip layer CV3′ using the inter-layer prediction information output from the second layer decoder 140-2 and transmits the decoding layer to the third output buffer 141-3. Finally, the decoding layer stored in the third output buffer 141-3 is output to the DPB 44-1.

Referring to FIGS. 1A, 2A, 3, and 6, when the bandwidth BW of the time varying communication channel 30 has a second value BW2, at time point t1, the first layer encoder 130-1 is disabled based on the encoder control code RC. According to the encoder control code RC, the second layer encoder 130-2 performs inter-encoding on differences between a previous frame and a current frame output from the second buffer 120-2 and generates the second coding layer CV2, i.e., predictive-coded frame and the second inter-layer prediction information ILP2. At time point t1, the third layer encoder 130-3 generates the second slice-skip layer CV3′ using the second inter-layer prediction information ILP2.

Referring to FIGS. 1A, 2B, 3, and 6, when the bandwidth BW of the time varying communication channel 30 has a second value BW2, at time point t1, each layer encoder 130-1, 130-2, and 130-3, which is enabled according to the encoder control code RC, outputs each coding layer CV1, CV2, and CV3.

According to the encoder control code RC, the MUX 140 sequentially outputs the second coding layer CV2 and the second slice-skip layer CV3′. Accordingly, when the bandwidth BW of the time varying communication channel 30 has the second value BW2, at time point t1, the second coding layer CV2 and the second slice-skip layer CV3′ are transmitted to the CPB 42 through the CPB 26 and the communication channel 30.

When the second coding layer CV2 and the second slice-skip layer CV3′ are transmitted to the CPB 42, the control block 44-2 outputs the first control code and the scaler 46 is disabled based on the first control code.

Under control of the control block 44-2, the first layer decoder 140-1 is disabled. The second layer decoder 140-2 decodes the second coding layer CV2 output from the control block 44-2 and transmits the decoding layer to the second output buffer 141-1. The second layer decoder 140-2 generates inter-layer prediction information and transmits the inter-layer prediction information to the third layer decoder 140-3.

The third layer decoder 140-3 decodes the second slice-skip layer CV3′ using the inter-layer prediction information output from the second layer decoder 140-2 and transmits a decoding layer to the third output buffer 141-3. Finally, the decoding layer stored in the third output buffer 141-3 is output to the DPB 44-1.

Referring to FIGS. 1A, 2A, 3, and 6, when the bandwidth BW of the time varying communication channel 30 has a third value BW3, at time point t2, both the first layer encoder 130-1 and the second layer encoder 130-2 are disabled based on the encoder control code RC. According to the encoder control code RC, the third layer encoder 130-3 performs inter-encoding on differences between a previous frame at time point t1 and a current frame output at time point t2, and generates the third coding layer CV3, i.e., predictive-coded frame.

Accordingly, when the bandwidth BW of the time varying communication channel 30 has the third value BW3, at time point t2, the third coding layer CV3 is transmitted to the CPB 42 through the CPB 26 and the communication channel 30.

Referring to FIGS. 1A, 2B, 3, and 6, when the bandwidth BW of the time varying communication channel 30 has the third value BW3, at time point t2, each layer encoder 130-1, 130-2, and 130-3, which is enabled according to the encoder control code RC, outputs each coding layer CV1, CV2, and CV3.

According to the encoder control code RC, the MUX 140 outputs the third coding layer CV3. When the third coding layer CV3 is transmitted to the CPB 42, the control block 44-2 outputs the first control code and the scaler 46 is disabled based on the first control code.

Under control of the control block 44-2, the first layer decoder 140-1 and the second layer decoder 140-2 are disabled. The third layer decoder 140-3 decodes the third coding layer CV3 and transmits the decoding layer to the DPB 44-1 through the third output buffer 141-3.

The third coding layer CV3 is transmitted to the CPB 42 at time point t3, the second coding layer CV2 and the second slice-skip layer CV3′ are transmitted to the CPB 42 at time point t4, the first coding layer CV1, the first slice-skip layer CV2′ and the second slice-skip layer CV3′ are transmitted to the CPB 42 at time point t5, the second coding layer CV2 and the second slice-skip layer CV3′ are transmitted to the CPB 42 at time point t6, and the third coding layer CV3 is transmitted to the CPB 42 at time point t7.

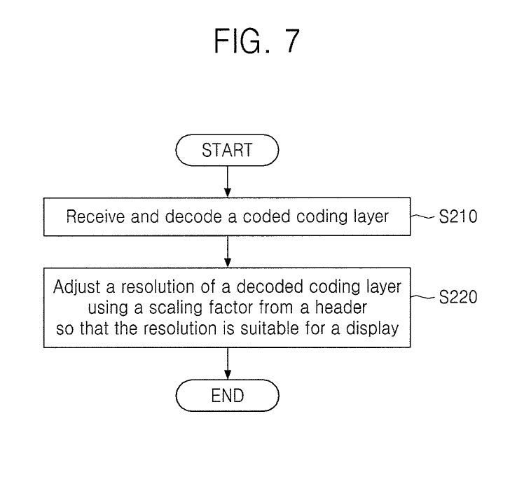

FIG. 7 illustrates a flowchart of a method of operating the scalable decoder 40A, 40B of FIG. 1A or 1B, according to an embodiment. Referring to FIGS. 1A, 1B, 3, 6, and 7, the scalable decoder receives an encoded coding layer and at least one slice-skip layer via the communication channel 30 and decodes the encoded coding layer and the at least one slice-skip layer, in operation S210. In operation 5220, the scalable decoder adjusts the resolution of the decoded coding layer so that the resolution is suitable for a display.

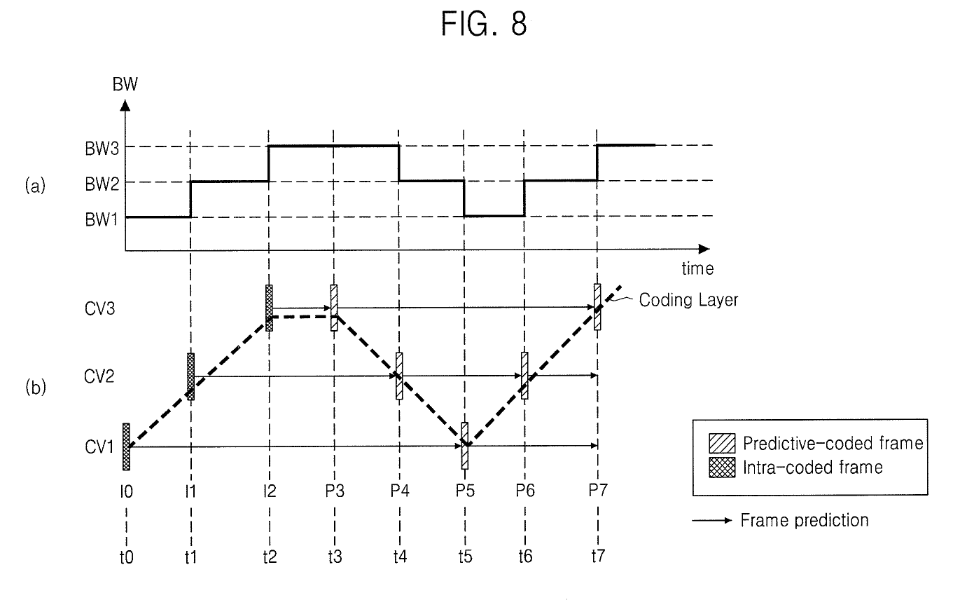

FIG. 8 illustrates a timing diagram for explaining an operation of the scalable encoder included in the data processing system of FIG. 1A or 1B based on variation of a bandwidth of a communication channel, according to another embodiment. In this embodiment, it is assumed that a display on which a decoded coding layer obtained by the scalable decoder 40A, 40B or the scalable decoding device 14A, 14B is displayed always displays an uppermost layer, i.e., a target resolution is fixed, and the scaler 46 is enabled or disabled based in the first control code. In this embodiment, only a coding layer selected in operation S30 or operation S120 may be encoded. Thus, coding efficiency may be maximized by allocating the entire bit budget to the coding layer, allowing layer switching to occur in accordance with bandwidth. When the coding layer is not the uppermost layer, the scaler 46 may be enabled to provide the target resolution.

Referring to FIGS. 1A, 2A, 3, and 8, when the bandwidth BW of the time varying communication channel 30 has a first value BW1, at time point t0, the first layer encoder 130-1 performs an intra-encoding on the current frame, i.e., QCIF output from the first buffer 120-1 based on the encoder control code RC, and generates the first coding layer CV1, i.e., the intra-coded frame I0. At the same time, the second layer encoder 130-2 and the third layer encoder 130-3 are disabled according to the encoder control code RC.

Referring to FIGS. 1A, 2B, 3, and 8, when the bandwidth BW of the time varying communication channel 30 has the first value BW1, at time point t0, each layer encoder 130-1, 130-2, and 130-3 enabled according to the encoder control code RC outputs each coding layer CV1, CV2, and CV3.

According to the encoder control code RC, the MUX 140 outputs only the first coding layer CV1. Thus, the first coding layer CV1 is transmitted to the CPB 42. When the first coding layer CV1 is transmitted to the CPB 42, the control block 44-2 outputs the first control code for enabling the scaler 46 and the second control code including a scaling factor to the scaler 46, and outputs the first coding layer CV1 to the first layer decoder 140-1 according to the header of the first coding layer CV1. At this time, the second layer decoder 140-2 and the third layer decoder 140-3 are disabled according to the encoder control code RC.

The first layer decoder 140-1 decodes the first coding layer CV1 and outputs a decoding layer to the first output buffer 141-1. The decoding layer buffered by the first output buffer 141-1 is transmitted to the scaler 46 through DPB 44-1. The scaler 46 scales up the decoding layer using the second control code, for example, a scaling factor. For example, QCIF scales up to the uppermost layer, i.e., 4CIF.

Referring to FIGS. 1A, 2A, 3, and 8, when the bandwidth BW of the time varying communication channel 30 has a second value BW2, at time point t1, the second layer encoder 130-2 performs an intra-encoding on the current frame, i.e., CIF output from the second buffer 120-2 based on the encoder control code RC and generates the second coding layer CV2, i.e., the intra-coded frame I1. At the same time, the first layer encoder 130-1 and the third layer encoder 130-3 are disabled according to the encoder control code RC.

Referring to FIGS. 1A, 2B, 3, and 8, when the bandwidth BW of the time varying communication channel 30 has the second value BW2, at time point t0, each layer encoder 130-1, 130-2, and 130-3, which is enabled according to the encoder control code RC, outputs each coding layer CV1, CV2, and CV3. According to the encoder control code RC, the MUX 140 outputs only the second coding layer CV2. Thus, the second coding layer CV2 is transmitted to the CPB 42.

When the second coding layer CV2 is transmitted to the CPB 42, the control block 44-2 outputs the first control code for enabling the scaler 46 and the second control code including a scaling factor to the scaler 46, and outputs the second coding layer CV2 to the first layer decoder 140-1 according to the header of the second coding layer CV2. At this time, the first layer decoder 140-1 and the third layer decoder 140-3 are disabled according to the encoder control code RC.

The second layer decoder 140-2 decodes the second coding layer CV2 and outputs a decoding layer to the second output buffer 141-2. The decoding layer buffered by the second output buffer 141-2 is transmitted to the scaler 46 through DPB 44-1. The scaler 46 scales up the decoding layer by using the second control code, for example, a scaling factor. For example, CIF scales up to the uppermost layer, i.e., 4CIF.

Referring to FIGS. 1A, 2A, 3, and 8, when the bandwidth BW of the time varying communication channel 30 has a third value BW3, at time point t2, the third layer encoder 130-3 performs an intra-encoding on the current frame, i.e., 4CIF output from the third buffer 120-3 based on the encoder control code RC and generates the third coding layer CV3, that is, the intra-coded frame I2. At the same time, the first layer encoder 130-1 and the second layer encoder 130-3 are disabled according to the encoder control code RC.

Referring to FIGS. 1A, 2B, 3, and 8, when the bandwidth BW of the time varying communication channel 30 has the third value BW3, at time point t2, each layer encoder 130-1, 130-2, and 130-3, which is enabled according to the encoder control code RC, outputs each coding layer CV1, CV2, and CV3.

According to the encoder control code RC, the MUX 140 outputs only the third coding layer CV3. Thus, the third coding layer CV3 is transmitted to the CPB 42. When the third coding layer CV3 is transmitted to the CPB 42, the control block 44-2 outputs the first control code for disabling the scaler 46 to the scaler 46 and outputs the third coding layer CV3 to the third layer decoder 140-3 according to the header of the third coding layer CV3. At this time, the first layer decoder 140-1 and the second layer decoder 140-2 are disabled according to the encoder control code RC.

The third layer decoder 140-3 decodes the third coding layer CV3 and outputs a decoding layer to the third output buffer 141-3. The decoding layer buffered by the third output buffer 141-3 is transmitted to the DPB 44-1. The decoding layer buffered by the DPB 44-1 bypasses the scaler 46 and is transmitted to the display (not shown).

At time point t3, the scalable encoder 20 performs an inter-encoding on differences between a current frame at time point t3 and a previous frame at time point t2 and outputs a predictive-coded frame P3, i.e., a third coding layer CV3. At time point t4, the scalable encoder 20A, 20B performs an inter-encoding on differences between a current frame at time point t4 and a previous frame at time point t1, and outputs a predictive-coded frame P4, i.e., a second coding layer CV2. At time point t5, the scalable encoder 20A, 20B performs an inter-encoding on differences between a current frame at time point t5 and a previous frame at time point t0, and outputs a predictive-coded frame P5, i.e., a first coding layer CV1. At time point t6, the scalable encoder 20A, 20B performs an inter-encoding on differences between a current frame at time point t6 and a previous frame at time point t4, and outputs a predictive-coded frame P6, i.e., a second coding layer CV2. At time point t7, the scalable encoder 20A, 20B performs an inter-encoding on differences between a current frame at time point t7 and a previous frame at time point t3, and outputs a predictive-coded frame P7, i.e., a third coding layer CV3.

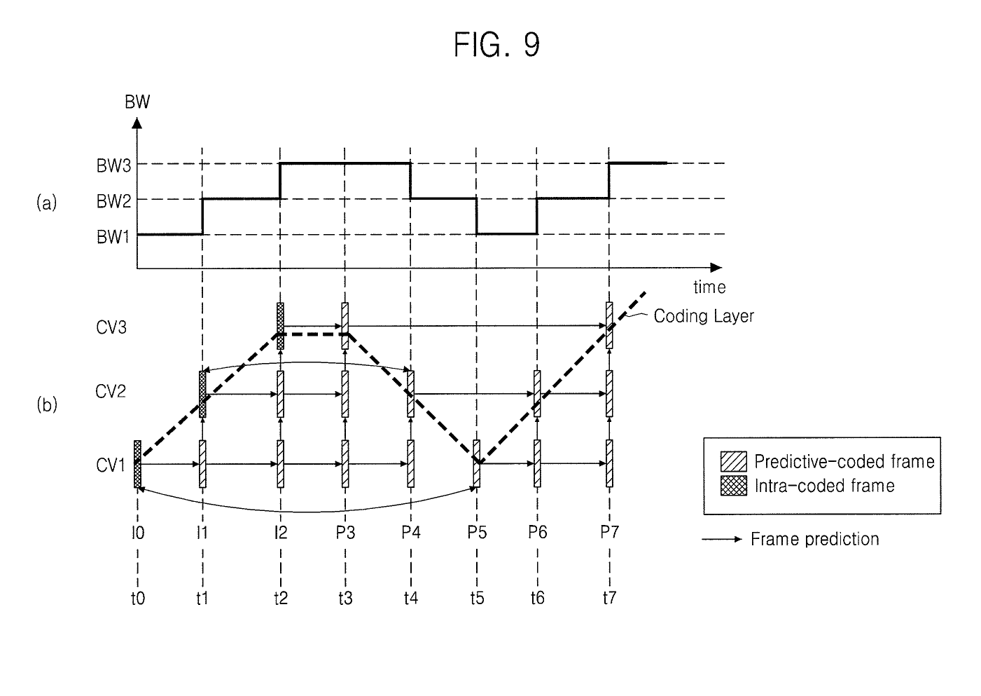

FIG. 9 illustrates a timing diagram for explaining an operation of the scalable encoder included in the data processing system of FIG. 1A or 1B based on variation of a bandwidth of a communication channel, according to still another embodiment. In this embodiment, a coding layer selected in operation S30 as well as all lower layers may be encoded. Thus, layer switching may occur in accordance with bandwidth. When the target layer is not the uppermost layer, the scaler 46 may be enabled to provide the target resolution.

Referring to FIGS. 1A, 2A, 3, and 9, when the bandwidth BW of the time varying communication channel 30 has a first value BW1, at time point t0, the first layer encoder 130-1 performs an intra-encoding on the current frame, e.g., QCIF, output from the first buffer 120-1 based on the encoder control code RC and generates the first coding layer CV1, i.e., the intra-coded frame I0. At the same time, the second layer encoder 130-2 and the third layer encoder 130-3 are disabled according to the encoder control code RC.

Referring to FIGS. 1A, 2B, 3, and 9, when the bandwidth BW of the time varying communication channel 30 has the first value BW1, at time point t0, each layer encoder 130-1, 130-2, and 130-3, which is enabled according to the encoder control code RC, outputs each coding layer CV1, CV2, and CV3. According to the encoder control code RC, the MUX 140 outputs only the first coding layer CV1. Thus, the first coding layer CV1 is transmitted to the CPB 42 via the CPB 26 and the communication channel 30.

When the first coding layer CV1 is transmitted to the CPB 42 via the communication channel 30, the control block 44-2 outputs the first control code for enabling the scaler 46, the second control code including a scaling factor to the scaler 16, and the first coding layer CV1 to the first layer decoder 140-1 according to the header of the first coding layer CV1. At this time, the second layer decoder 140-2 and the third layer decoder 140-3 are disabled according to the encoder control code RC.

The first layer decoder 140-1 decodes the first coding layer CV1 and outputs a decoding layer to the first output buffer 141-1. The decoding layer buffered by the first output buffer 141-1 is transmitted to the scaler 46 through DPB 44-1. The scaler 46 scales up the decoding layer by using the second control code, for example, a scaling factor.

For example, when the resolution of the display is 4CIF, QCIF scales up to the uppermost layer, i.e., 4CIF according to the scaling factor. In addition, when the resolution of the display is CIF, QCIF scales up to the uppermost layer, i.e., CIF according to the scaling factor. That is, the control block 44-2 adjusts the scaling factor according to the resolution of the display. During an initial session or initialization, the control block 44-2 acquires information of a resolution of a display connected to the scalable decoding device 14A, 14B. Accordingly, the control block 44-2 generates a second control code including a scaling factor based on the information of the resolution and information included an input coding layer.

Referring to FIGS. 1A, 2A, 3, and 9, when the bandwidth BW of the time varying communication channel 30 has a second value BW2, at time point t1, the first layer encoder 130-1 performs an inter-encoding on differences between a current frame at time point t1 and a previous frame at time point t0 based on the encoder control code RC, and generates the first coding layer CV1 and a first inter-layer prediction information ILP1.

At time point t1, the second layer encoder 130-2 performs an intra-encoding a current frame output from the second buffer 120-2 using the first inter-layer prediction information ILP1 and generates the second coding layer, i.e., intra-coded frame. At the same time, the third layer encoder 130-3 is disabled according to the encoder control code RC.

Referring to FIGS. 1A, 2B, 3, and 9, when the bandwidth BW of the time varying communication channel 30 has the second value BW2, at time point t1, each layer encoder 130-1, 130-2, and 130-3, which is enabled according to the encoder control code RC, outputs each coding layer CV1, CV2, and CV3. According to the encoder control code RC, the MUX 140 outputs the first coding layer CV1, i.e., the predictive-coded frame, and the second coding layer CV2, i.e., the intra-coded frame. Thus, the first coding layer CV1 and the second coding layer CV2 are sequentially transmitted to the CPB 42 via the CPB 26 and the communication channel 30.

When the first coding layer CV1 and the second coding layer CV2 are transmitted to the CPB 42 via the communication channel 30, the control block 44-2 outputs the first control code for enabling the scaler 46 and the second control code including a scaling factor to the scaler 46, and outputs the first coding layer CV1 to the first layer decoder 140-1 according to the header of the first coding layer CV1. At this time, the second layer decoder 140-2 and the third layer decoder 140-3 are disabled according to the encoder control code RC.

The first layer decoder 140-1 decodes the first coding layer CV1 and outputs a decoding layer to the first output buffer 141-1. The decoding layer buffered by the first output buffer 141-1 is transmitted to the scaler 46 through DPB 44-1. The scaler 46 scales up the decoding layer by using the second control code, for example, a scaling factor.

According to some embodiments, when the resolution of the display is 4CIF, QCIF scales up to the uppermost layer, i.e., 4CIF according to the scaling factor. According to other embodiments, when the resolution of the display is CIF, QCIF scales up to the uppermost layer, i.e., CIF according to the scaling factor.

Referring to FIGS. 1A, 2A, 3, and 9, when the bandwidth BW of the time varying communication channel 30 has a third value BW3, at time point t2, the first layer encoder 130-1 performs an inter-encoding on differences between a current frame at time point t2 and a previous frame at time point t1 based on the encoder control code RC, and generates the first coding layer CV1 and a first inter-layer prediction information ILP1.

At time point t2, the second layer encoder 130-2 performs an inter-encoding on differences between a current frame at time point t2 and a previous frame at time point t1 based on the encoder control code RC, and generates the second coding layer CV2 and the second inter-layer prediction information ILP2. According to some embodiments, the second layer encoder 130-2 performs an inter-encoding on a current frame using the first inter-layer prediction information ILP1 and generates the second coding layer CV2 and the second inter-layer prediction information ILP2 at time point t2.

The third layer encoder 130-3 performs an intra-encoding on a current frame by using the second inter-layer prediction information ILP2 and generates the third coding layer CV3.

Referring to FIGS. 1A, 2B, 3, and 9, when the bandwidth BW of the time varying communication channel 30 has the third value BW3, at time point t2, each layer encoder 130-1, 130-2, and 130-3, which is enabled according to the encoder control code RC, outputs each coding layer CV1, CV2, and CV3. According to the encoder control code RC, the MUX 140 outputs the first coding layer CV1, i.e., the predictive-coded frame, the second coding layer CV2, i.e., the predictive-coded frame, and the third coding layer CV3, i.e., the intra-coded frame. Thus, the first coding layer CV1, the second coding layer CV2, and the third coding layer CV3 are sequentially transmitted to the CPB 42 via CPB 26 and the communication channel 30.

The control block 44-2 outputs the coding layers CV1, CV2, and CV3 to the layer decoders 140-1, 140-2, and 140-3, respectively.

At time point t3, the scalable encoder 20 outputs each predictive-coded frame CV1, CV2, and CV3. At time point t4, the first layer encoder 130-1 performs an inter-encoding on a current frame at time point t4 and a previous frame at time point t3, and the second layer encoder 130-2 performs an inter-encoding on a current frame at time point t4 and a previous frame at time point t1. At time point t5, the first layer encoder 130-1 performs an inter-encoding on a current frame at time point t5 and a previous frame at time point t0.

The scaler 46 adjusts a resolution of decoding layer using a scaling factor included in the second control code so that the resolution is suitable for a display connected to the scalable decoding device 14.

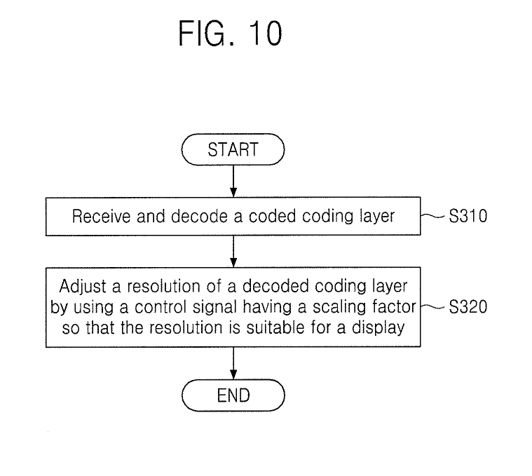

FIG. 10 illustrates a flowchart of a method of operating the scalable decoding device 14A, 14B of FIG. 1A or 1B, according to another embodiment. Referring to FIGS. 1A, 1B, 3, and 8-10, the scalable decoding device receives an encoded coding layer via the communication channel 30 and decodes the encoded coding layer, in operation S310.

In operation S320, the scaler 46 of the scalable decoding device adjusts the resolution of the decoded coding layer using a second control code including a scaling factor so that the resolution is suitable for a display.

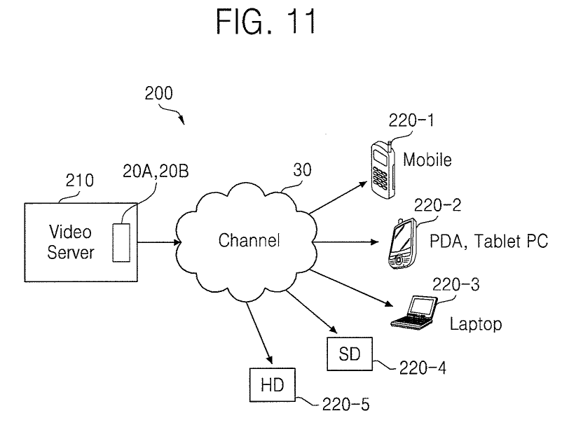

FIG. 11 illustrates a block diagram of a data processing system 200 according to another embodiment that includes a scalable encoder and a scalable decoder. Referring to FIG. 11, the data processing system 200 includes a video server 210 including the scalable encoder 20A, 20B, a communication channel 30, and a plurality of heterogeneous receiving devices, namely, first through fifth receiving devices 220-1 through 220-5. Each of the first through fifth receiving devices 220-1 through 220-5 includes the scalable decoder 40a, 40B or the scalable decoding device 14A, 14B according to an embodiment.

The first receiving device 220-1 may be a mobile phone that includes a small display with a Quarter-QVGA (QQVGA) resolution. The second receiving device 220-2 may be a personal digital assistant (PDA), a portable multimedia player (PMP), a smart phone, a tablet PC, and so forth, that includes a medium display with a Quarter Video Graphics Array (QVGA) resolution.

The third receiving device 220-3 may be a laptop computer or a personal computer (PC) that includes a large display with a Video Graphics Array (VGA) resolution. The fourth receiving device 220-4 may be a digital TV or an IPTV that includes a display with a standard definition (SD) resolution. The fifth receiving device 220-5 may be a digital TV or an IPTV that includes a display with a high definition (HD) resolution.

The scalable encoder 20A, 20B encodes a coding layer suitable for a bandwidth of the time varying communication channel 30 from among a plurality of dependency layers, and transmits an encoded coding layer corresponding to a result of the encoding to the communication channel 30.

The scalable decoder 40A, 40B or the scalable decoding device 14A, 14B included in each of the heterogeneous receiving devices 220-1 through 220-5 may decode the encoded coding layer and/or the encoded scaling factor received via the communication channel 30, and adjust the resolution of a decoded coding layer according to a scaling factor so that the resolution is suitable for each of the displays of the heterogeneous receiving devices 220-1 through 220-5.

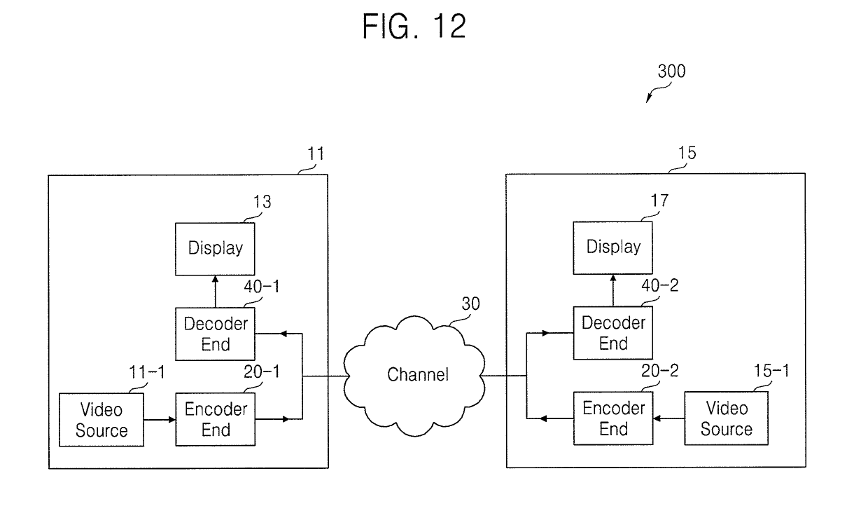

FIG. 12 illustrates a block diagram of a data processing system 300 according to still another embodiment that includes a scalable encoder and a scalable decoder. Referring to FIG. 12, the data processing system 300 includes a first video signal processing device 11 and a second video signal processing device 15 that communicate with each other via the communication channel 30.

The first video signal processing device 11 includes a first video source 11-1, a first scalable encoder 20-1, a first scalable decoder 40-1, and a first display 13.

The first video source 11-1 provides a raw video signal to the first scalable encoder 20-1, and a structure and an operation of the first scalable encoder 20-1 and the first scalable decoder 40-1 are substantially the same as those of the scalable encoder 20A, 20B and of the scalable decoder 40A, 40B or the scalable decoding device 14A, 14B of FIG. 1A or 1B, respectively. The first scalable encoder 20-1 transmits an encoded coding layer and/or at least one scaling factor to a second scalable decoder 40-2 of the second video signal processing device 15 via the communication channel 30.

The first scalable decoder 40-1 receives an encoded coding layer and/or at least one scaling factor from a second scalable encoder 20-2 of the second video signal processing device 15 via the communication channel 30, decodes the encoded coding layer and/or the at least one scaling factor to obtain a decoded coding layer or a scale-adjusted decoded coding layer, and provides the decoded coding layer or the scale-adjusted decoded coding layer to the first display 13.

The second video signal processing device 15 includes a second video source 15-1, the second scalable encoder 20-2, a second scalable decoder 40-2, and a second display 17.

The second video source 15-1 provides a row video signal to the second scalable encoder 20-2, and a structure and an operation of the second scalable encoder 20-2 and the second scalable decoder 40-2 are substantially the same as those of the scalable encoder 20A, 20B and of the scalable decoder 40A, 40B or the scalable decoding device 14 A, 14B of FIG. 1A or 1B, respectively. The second scalable encoder 20-2 transmits an encoded coding layer and/or at least one scaling factor to the first scalable decoder 40-1 of the first video signal processing device 11 via the communication channel 30.

The second scalable decoder 40-2 receives the encoded coding layer and/or the at least one scaling factor from the first scalable encoder 20-1 of the first video signal processing device 11 via the communication channel 30, decodes the encoded coding layer and/or the at least one scaling factor to obtain a decoded coding layer or a scale-adjusted decoded coding layer, and provides the decoded coding layer or the scale-adjusted decoded coding layer to the second display 17.

By way of summation and review, embodiments are directed to methods of performing scalable video coding (SVC) and devices capable of performing the methods, by which a coding layer suitable for the bandwidth of a time varying communication channel from among a plurality of dependency layers or spatial layers can be encoded and transmitted.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A data processing method, comprising:
initializing an encoder configuration for an encoder having at least a first layer encoder and a second layer encoder;
determining transmission conditions of a communication channel;
generating an encoder control signal in accordance with the transmission conditions; and
controlling at least one of the first and second layer encoders to encode at least a coding layer in accordance with the encoder control signal.

2. The method as claimed in claim 1, wherein controlling the first and second layer encoders includes controlling each of the first and second layer encoders enabled in accordance with the encoder control signal to perform one of an intra-encoding operation, an inter-encoding operation, a slice-skip encoding operation, and a no-encoding operation based on the encoder control signal.

3. The method as claimed in claim 2, further comprising, as the transmission conditions improve, increasing a number of layer encoders enabled by the encoder control signal.

4. The method as claimed in claim 1, further comprising determining the coding layer from among at least two layers in accordance with the transmission conditions of the channel.

5. The method as claimed in claim 4, further comprising:
when the coding layer is an uppermost layer, transmitting the encoded coding layer; and
when the coding layer is not the uppermost layer, transmitting the encoded coding layer and at least one scaling factor.

6. The method as claimed in claim 5, wherein the at least one scaling factor is from a layer other than the coding layer.

7. The method as claimed in claim 4, wherein controlling includes controlling the first and second layer encoders to encode the coding layer and all layers above the coding layer.

8. The method as claimed in claim 4, wherein controlling includes controlling the first and second layer encoders to encode the coding layer and all layers below the coding layer.

9. The method as claimed in claim 4, wherein controlling includes controlling the first and second layer encoders to encode only the coding layer.

10. The method as claimed in claim 1, wherein, when more than one layer encoder is enabled, a lower layer encoder encodes an input bit stream and outputs inter-layer prediction information to an upper layer encoder.

11. The method as claimed in claim 10, wherein the upper layer encoder outputs a scaling factor.

12. The method as claimed in claim 10, wherein the lower encoding layer outputs an encoded bit stream.

13. The method as claimed in claim 1, further comprising:
receiving an encoded coding layer over the communication channel;
decoding the encoded coding layer; and
adjusting a resolution of a decoded coding layer.

14. The method as claimed in claim 13, wherein adjusting the resolution includes using a scaling factor from a layer other than the coding layer.

15. The method as claimed in claim 13, wherein adjusting the resolution includes using a predetermined scaling factor.

16. The method as claimed in claim 13, wherein decoding includes generating a decoding control signal for controlling at least two layer decoders, corresponding to the at least two layer encoders.

17. The method as claimed in claim 16, wherein, when more than one layer decoders is enabled, a lower layer decoder decodes the encoded coding layer and outputs inter-layer prediction information to an upper layer decoder.

18. The method as claimed in claim 17, further comprising supplying only an output of the upper layer decoder to a decoded buffer.

19. The method as claimed in claim 17, wherein, when the upper layer decoder receives only a header from a coded buffer, adjusting the resolution of the decoded coding layer includes using a scaling factor from the header to adjust the resolution of the decoded coding target layer output by the lower layer decoder.

20. The method as claimed in claim 1, wherein controlling the first and second layer encoders includes simultaneously enabling the first and second layer encoders, multiplexing outputs from the first and second layer encoders, and outputting outputs from the first and second layer encoders in accordance with the encoder control signal.

21. The method as claimed in claim 1, further comprising repeating determining, generating, and controlling for all access units.

22. The method as claimed in claim 21, wherein, when no coding layer is found for a current access unit based on current transmission conditions, skipping the current access unit.

23. A scalable encoder, comprising:
an encoder including at least two layer encoders; and
a control module configured to generate a encoder control code in accordance with transmission conditions of a communication channel, the encoder control code controlling operation of the at least two layer encoders.

24. The scalable encoder as claimed in claim 23, wherein the encoder and the control module are incorporated in a single chip.

25. The scalable encoder as claimed in claim 24, wherein the control module includes a transmission condition estimator configured to estimate current transmission conditions of the communication channel.

26. The scalable encoder as claimed in claim 25, wherein the control module includes an encoding type decision block configured to determine a coding layer based on the current transmission conditions.

27. The scalable encoder as claimed in claim 25, further comprising a transmission buffer, wherein the transmission condition estimator estimates current transmission conditions based on a bit level of the transmission buffer.

28. The scalable encoder as claimed in claim 27, wherein the transmission buffer is on the single chip.

29. The scalable encoder as claimed in claim 23, wherein the encoder includes a multiplexer configured to receive encoded coding layers encoded by the at least two layer encoders and to selectively output encoded coding layers in accordance with the encoder control code.

30. The scalable encoder as claimed in claim 29, wherein the encoder control code simultaneously enables all of the at least two layer encoders.

31. The scalable encoder as claimed in claim 23, wherein the control module is configured to control each layer encoder to perform one of an intra-encoding operation, an inter-encoding operation, a slice-skip encoding operation, and a no-encoding operation based on the encoder control signal.

32. The scalable encoder as claimed in claim 23, wherein, as transmission conditions of the communication channel improve, the encoder control code enables more layer encoders.

33. The scalable encoder as claimed in claim 23, wherein, as transmission conditions of the communication channel improve, the encoder control code enables fewer layer encoders.

34. The scalable encoder as claimed in claim 23, wherein encoder control code enables only one layer encoder.

35. A data processing system, comprising:
a scalable encoder including an encoder and a control module, wherein
the encoder includes at least two layer encoders and has an encoder configuration determined during initialization,
the control module is configured to generate a encoder control code in accordance with transmission conditions of a communication channel, the encoder control code controlling operation of the at least two encoding layers.

36. The data processing system as claimed in claim 35, wherein the encoder and the control module are incorporated in a single chip.

37. The data processing system as claimed in claim 35, further comprising a monitor in the scalable encoder, the monitor configured to perform a handshake operation over the communication channel and supplying transmission conditions of the communication channel to the control module.

38. The data processing system as claimed in claim 35, wherein the control module is configured to control each layer encoder to perform one of an intra-encoding operation, an inter-encoding operation, a slice-skip encoding operation, and a no-encoding operation based on the encoder control signal.

39. The data processing system as claimed in claim 35, wherein, as transmission conditions of the communication channel improve, the encoder control code enables more layer encoders.

40. The data processing system as claimed in claim 35, wherein, as transmission conditions of the communication channel improve, the encoder control code enables fewer layer encoders.

41. The data processing system as claimed in claim 35, wherein the encoder control code enables only one layer encoder.

42. The data processing system as claimed in claim 35, further comprising a scalable decoding device including a scalable decoder having at least two layer decoders, corresponding to the at least two layer encoders of the scalable encoder, the scalable decoder configured to decode an encoded coding layer and the scalable decoding device configured to adjust a resolution of the decoded coding layer.

43. The data processing system as claimed in claim 42, further comprising a decoded picture buffer, the decoded picture buffer receiving a single output from the scalable decoder.

44. The data processing system as claimed in claim 42, wherein the scalable decoder includes a control block configured to supply encoded information to respective layer decoders.

45. The data processing system as claimed in claim 44, wherein, when the control block enables more than one layer decoder, a lower decoding layer decodes an encoded coding layer and outputs inter-layer prediction information to an upper layer decoder.

46. The data processing system as claimed in claim 45, wherein, when the upper layer decoder receives only a header from the control block, the scalable decoding device adjusts the resolution of the decoded coding layer using a scaling factor from the header to adjust the resolution of the decoded coding layer output by the lower decoding layer.

47. The data processing system as claimed in claim 44, further comprising a scaler external to the scalable decoder, the scaler configured to scale an output from the scalable decoder, the control block being configured to control operation of the scaler.

48. The data processing system as claimed in claim 47, wherein, when the control block enables the scaler, the control block generates a scaling factor to be used by the scaler.

49. The data processing system as claimed in claim 48, when the control block enables more than one layer decoder, a lower layer decoder decodes the encoded coding layer and outputs inter-layer prediction information to an upper layer decoder.

50. The data processing system as claimed in claim 47, when the control block only enables a single layer decoder, the control block enables the scaler to adjust the resolution of an output from the single layer decoder using a predetermined scaling factor.

51. The data processing system as claimed in claim 42, wherein the scalable encoder is implemented as a first system on chip and the scalable decoding device is implemented as a second system on chip.

52. The data processing device as claimed in claim 51, wherein the scalable encoder and the scalable decoding device are on a single system on chip.
